(19) United States
(12) Patent Application Publication
(10) Pub. No.: US 2014/0058762 A1
(43) Pub. Date: Feb. 27, 2014

(54) METHODS AND SYSTEMS FOR CONSUMER CONTROLLED INSURANCE DATA MANAGEMENT

(71) Applicant: Zubie, Inc., Bloomington, MN (US)

(72) Inventors: Michael John Rude, Excelsior, MN (US); Ari Abram Silkey, Burnsville, MN (US)

(73) Assignee: Zubie, Inc., Bloomington, MN (US)

(21) Appl. No.: 13/972,400

(22) Filed: Aug. 21, 2013

Related U.S. Application Data
(60) Provisional application No. 61/691,987, filed on Aug. 22, 2012.

(51) Int. Cl. G06Q 40/08

(52) U.S. Cl. CPC G06Q 40/08
USPC 705/4

(57) ABSTRACT

One embodiment is directed to a method for data management for insurance purposes. The method includes receiving, at a server, time-variant data from a retail module configured to obtain the time-variant data, wherein the time-variant data pertains to an item or intangible to be insured. Identification information is also received at the server from the retail module. The method includes determining a user account with which the retail module is associated based on the identification information, and receiving a selection from a user indicative of which one or more insurance providers to send the time-variant data to, wherein the user is associated with the user account. The time-variant data is provided, from the server, to the one or more insurance providers selected by the user.

### CROSS-REFERENCE TO RELATED APPLICATIONS

This application claims the benefit of U.S. Provisional Patent Application Ser. No. 61/691,987, filed on Aug. 22, 2012, which is hereby incorporated herein by reference.

### BACKGROUND

Usage-based Insurance (UBI) models exist in which an electronic device provided by, and under the control of, an insurance provider produces data of relevance to that insurance provider. These devices are associated with a single insurance provider and provide their data to the insurance provider for their sole use. The data is not available to the consumer for use with other insurance providers. Moreover, the devices are typically only provided after opening a policy with the particular insurance provider.

### SUMMARY

One embodiment is directed to a method for data management for insurance purposes. The method includes receiving, at a server, time-variant data from a retail module configured to obtain the time-variant data, wherein the time-variant data pertains to an item or intangible to be insured. Identification information is also received at the server from the retail module. The method includes determining a user account with which the retail module is associated based on the identification information, and receiving a selection from a user indicative of which one or more insurance providers to send the time-variant data to, wherein the user is associated with the user account. The time-variant data is provided, from the server, to the one or more insurance providers selected by the user.

### DRAWINGS

FIG. 1 is a block diagram of an example system for consumer controlled insurance data management.

FIG. 2 is a block diagram of an example retail module for use in the system of FIG. 1.

FIG. 3 is a block diagram of another example retail module for use in the system of FIG. 1.

FIG. 4 is a block diagram of an example data management server for use in the system of FIG. 1.

### DETAILED DESCRIPTION

Embodiments described herein provide for systems and methods for data management in which time-variant data of relevance to insurance is obtained under the control of the consumer. In one example, a module that is not specific to any insurance provider is provisioned for use by a consumer. The module can be a module provided by a data management entity that is able to obtain quotes from multiple insurance providers. The module can obtain or otherwise generate data of interest to one or more insurance providers. The module communicates some or all of its accumulated data to a data management entity (e.g., to a server of the data management entity), and the data management entity can provide such data, or portions thereof, to one or more insurance providers along with identifying information for a consumer interested in the insurance. The insurance providers can then provide quotes based on the data for the consumer.

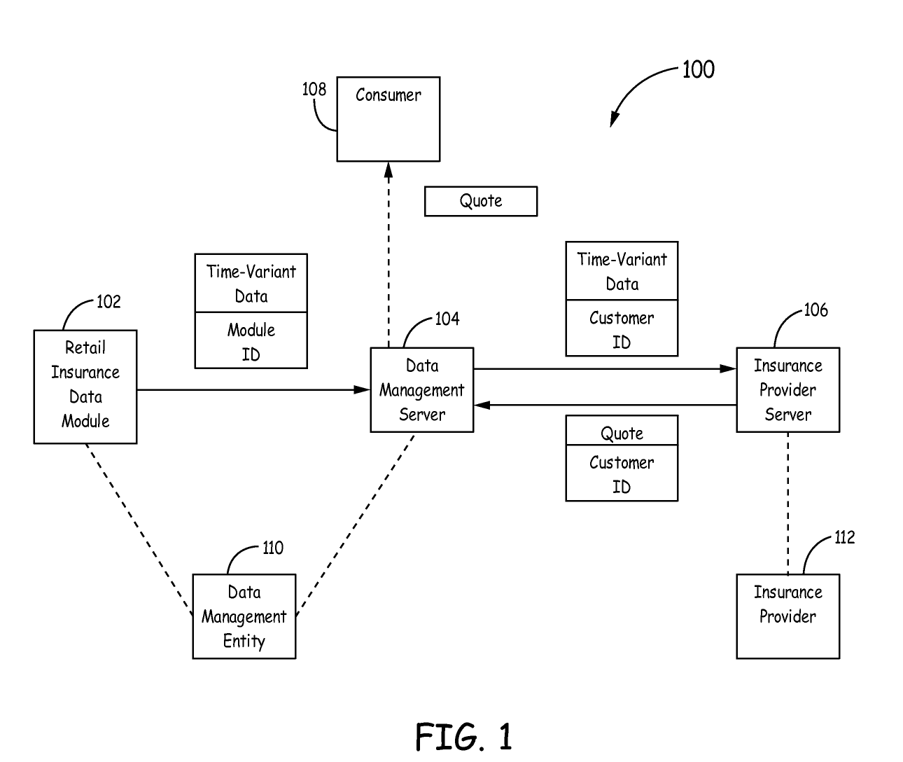

FIG. 1 is a block diagram of an example of such a system 100. System 100 includes a retail module 102, a data management server 104, and an insurance provider server 106. A consumer 108 can obtain the retail module 102 from a retail store. The retail store 102 can include a brick and mortar store or an online store, and the consumer 108 can purchase the module or receive the module free of charge.

The retail module 102 is associated with a data management entity 110 and is configured to communicate with the data management server 104. The retail module 102 is configured to obtain or otherwise generate data that relates to a time-varying characteristic of an item or intangible to be insured. A time-varying characteristic, as used herein, is a characteristic that typically changes on the order of a week, day, hour, minute, or less (e.g. millisecond). Such time-varying characteristics are difficult to capture in a written insurance application, because of their nature of changing over time. For example, a location of a house does not typically ever change, and in the rare instance that it does, it will not change on even a weekly basis. Therefore, the location of a house is not considered time-varying characteristic as used herein. A location of a vehicle, however, can change on an hourly basis or faster and therefore is considered a time-varying characteristic as used herein. Similarly, a position of a garage door in a house is a time-varying characteristic as used herein since the garage door position can change on an hourly basis or faster. Other examples of time-varying characteristics are provided below. The data obtained by the retail module 102 corresponding to a time-varying characteristic is also referred to herein as “time-variant data”. The retail module 102 is configured to monitor phenomenon relevant to the item or intangible to obtain the time-variant data.

In one example, the retail module 102 is an electronic device configured to be installed in a vehicle to monitor characteristics relating to how the vehicle is driven. Such a retail module 102 can obtain time-variant data including data related to acceleration, speed, stopping patterns, location, driving duration, miles driven, the number of times the retail module 102 is connected and disconnected (e.g., from a vehicle's data bus), etc., for the vehicle. In an implementation of such a retail module 102, the electronic device is configured to connect to the vehicle's data bus through an appropriate connector such as an SAE-J1962 standard connector. The SAE-J1962 connector is the connector for the OBD-II protocol described in the SAE-J1978 standard. The electronic device can obtain data from the vehicle's sensors over the vehicle's data bus. This data can be used to ascertain driving characteristics. In one implementation, the electronic device can also include its own one or more sensors, such as an accelerometer, a global navigation satellite system (GNSS) receiver (e.g., a global positioning system (GPS) receiver), and/or a gyroscope, to generate its own data corresponding to the vehicle's driving characteristics. In another implementation, the electronic module 102 is a software program that is installed on an electronic device (e.g., a mobile phone) having sensors that can monitor the vehicle's driving characteristics. The data (time-variant data) obtained by such a retail module 102 can be used by an insurance provider 112 for insurance on the vehicle.

In some implementations, such as when the retail module 102 is coupled to a vehicle's data bus, the retail module 102 can also obtain identifying information for the vehicle or other item to which the retail module 102 is monitoring. This information can be used to verify that the retail module 102 is, in fact, monitoring the correct vehicle. The retail module 102 can also record other time-variant data not directly for insurance purposes, such as the fuel level, miles per gallon, etc. This data can be used for various purposes including verification by the data management entity 110 or insurance provider 112 that the retail module 102 is being used as intended.

In another implementation, the retail module 102 is a heart monitor configured to monitor a heart rate of the consumer 108. Such a retail module 102 can monitor the heart rate of the individual to ascertain data such as normal resting heart rate and frequency of vigorous activity. This data (time-variant data) can be used by an insurance provider 112 for life or health insurance for the consumer 108.

In another implementation, the retail module 102 is a home monitor that can be coupled to a home security or other monitoring system. Such a home monitor can collect time-variant data including a duration and/or timing of garage door being open, doors being unlocked, or windows being open. This data (time-variant data) can be used by an insurance provider 112 for home insurance for the consumer 108.

In other implementations, other retail modules 102 can be used to provide vehicle (e.g., car, boat, ATV, snowmobile, motorcycle), life, health, home, or other insurance for the consumer 108.

In any case, the retail module 102 is configured to communicate the time-variant data obtained or otherwise generated to the data management entity 110. The retail module 102 is also configured to communicate identification information for the retail module 102 to the data management entity 110. This communication can take any suitable form. For example, the retail module 102 can be configured to communicate the insurance information to a server 104 (also referred to herein as the “data management server”) associated with and under the control of the data management entity 110. In one implementation, the retail module 102 is configured to wirelessly communicate with a cellular tower from which signals can be sent over the internet to the data management server 104. In another implementation, the retail module 102 is configured to communicate with a local area network that is coupled to the internet, such that the time-variant data can be provided to the local area network, through the internet, and to the data management server 104. The local area network can be a wireless or wired local area network. In yet another implementation, the retail module 102 is configured to communicate with a personal computing device that can be coupled to the internet. In such implementations, the retail module 102 can be configured to send the time-variant data to the personal computing device and the personal computing device can forward the time-variant data on to the data management server 104.

In examples where the retail module 102 is an electronic device, the retail module 102 can include the electronic components for communication with the appropriate device, such as a wireless transceiver for communication with a cellular tower or a wireless access point, or a transceiver for communication over a wired medium such as a CAT-5 cable. In examples where the retail module 102 is a software program, the electronic device in which the software program is installed can include such components.

Depending on the capabilities of the retail module 102 or the hardware on which the retail module 102 is installed, the retail module 102 can be configured to upload the time-variant data to the data management server 104 on a real-time, periodic, or on-demand basis. For example, in implementations where the retail module 102 is capable of connecting to a cell tower, the time-variant data can be uploaded to the data management server 104 in real-time. In other examples, the retail module 102 can buffer the time-variant data and periodically upload the time-variant data. In yet other examples, the retail module 102, such as when the retail module 102 communicates by connecting through a wired connection to a personal computer, the retail module 102 can provide the time-variant data in response to a command from the consumer 108.

Before obtaining or otherwise generating time-variant data, the retail module 102 can be physically installed, if necessary, by the consumer 108. In the electronic device for installation in a vehicle example discussed above, physically installing the electronic device can include connecting the electronic device to an SAE-J1962 standard connector in the vehicle to be insured. In examples where the retail module 102 is a software program, the software program can be downloaded from the internet or a physical media, such as a compact-disk, and installed on an electronic device.

The retail module 102 can be provisioned by the data management entity 110. Provisioning can include providing the data management entity 110 (e.g., the data management server 104) with identification information for the consumer 108 and the item or intangible for which insurance is sought. For example, identification information sufficient to open an account for the consumer 108 can be obtained and, in the case of vehicle insurance, identifying information for the vehicle such as VIN, or make, model, year, and mileage. Provisioning can also include providing the data management entity 110 (e.g., the data management server 104) with identification information for the retail module 102 (e.g., a unique ID such as a serial number). In some examples, provisioning can include unlocking the retail module 102 such that it can operate. The unlocking can occur via a communication from the data management server 104 to the retail module 102, or by having the customer 101 input a code that is received (e.g., via email or voice call) from an individual at the data management entity 110 or the data management server 104.

The data management server 104 is configured to receive the time-variant data and other related data from the retail module 102. The data management server 104 can maintain a database or other file system associating together the identification information for the customer 108, the identification information for the retail module 102, the time-variant data received from the retail module 102, and any other relevant information such as identification information for the vehicle or other item to which the retail module 102 is monitoring. The identification information for the customer 108 and the identification information for the retail module 102 can be part of a user account and can be input into the data management server 104 by an individual at the data management entity 110, can be data received from the retail device 102, or can be data input by the consumer 108 via a web portal. The retail module 102 can send identification information for itself as well as other data (e.g., number of times unplugged and identification of item monitored) with the time-variant data to the data management server 104. The data management server 104 can appropriately associate the time-variant data and other data with the user account based on the identification information of the retail module 102. In some examples, the data management server 104 can associate the time-variant data with the appropriate user account based on other data obtained by the retail module 102, such as a VIN number of a vehicle. The data management server 104 can maintain multiple such associations for multiple user accounts in the database or other file system.

The data management entity 110 can provide the time-variant data along with some or all of the identification information for the user account/customer 108 to one or more insurance providers 112. For example, the data management server 104 can send a communication including such information to the insurance provider server 106 for each desired insurance provider 112. As used herein, an insurance provider is an entity that issues an insurance policy that promises to compensate the insured in the case of a loss. Example insurance providers include, without limitation, State Farm, Progressive, and Allstate. The insurance provider server 106 is a server that includes software that can act on insurance information (e.g., generate a quote) on behalf of an insurance provider 112. Examples of an insurance provider server 106 include a server under direct control and potentially at a location owned by an insurance provider 112, and a server under control of an agent of the insurance provider, such as a direct or independent agent. Providing the time-variant data from the data management server 104 to the insurance provider server 106 can include providing the data through one or more intermediary devices. For example, the time-variant data can be provided from the data management server 104 to a server of an insurance broker from which the time-variant data is provided to one or more insurance providers 112.

A single retail module 102 can provide time-variant data for multiple insurance providers 112. That is, the time-variant data from a single retail module 102 can be provided to multiple insurance providers 112. In some examples, time-variant data from multiple retail modules 102 can be aggregated and provided to an insurance provider 112. For example, time-variant data from a first retail module 102 which is an electronic device that plugs into an OBD port of a vehicle can be combined with time-variant data from a second retail module 102 which is software executing on a mobile phone. These two retail modules 102 can both be associated with a single insured item (e.g., a vehicle) and the respective sets of time-variant data can be aggregated as an aggregated set of time-variant data for the insured item. The aggregated set can then be provided to one or more insurance providers 112.

Each insurance provider 112, upon receiving the information from the data management server 104, can generate a quote for the consumer 108 based on the information provided by the data management server 104. In some examples, the insurance provider 112 may request additional information for the consumer 108 and can obtain such information by asking the data management entity 110 to obtain the information or by contacting the consumer 108 directly. Each insurance provider 112 may have a proprietary method of determining a quote, with varying amount of reliance on the time-variant data obtained by the retail module 102.

Each insurance provider 112 can then send their quote to the consumer 108. In one example, the quotes are sent to the data management server 104 which then provides such quotes to the consumer 108. In another example, the quotes can be sent directly from the insurance providers 112 to the consumer 108. In examples where the quotes are provided to the data management server 104, the data management server 104 can send an email to the consumer 108 containing the quotes from the one or more insurance providers 112. As another example, the data management server 104 can maintain a web portal into which the customer 108 can log-in to view the quotes. Notably, a quote received by the data management server 104 is an actual quote from an insurance provider 112 and for insurance from that insurance provider 112. The quote is not merely an estimate by a third party based on knowledge of the insurance provider's practice. The quote can be accepted by the consumer 108 to open an insurance policy with the given insurance provider. Upon receiving quotes, the consumer 108 can select a quote and open up an insurance policy with the corresponding insurance provider 112.

In an example, the data management server 104 can automatically send the time-variant data and any other data to all appropriate insurance providers 112 to obtain quotes from all the insurance providers 112. In another example, the data management server 104 can provide a list of potential insurance providers 112 to the consumer 108 (e.g., via email or web portal) and can receive a selection of which one or more insurance providers 112 the consumer 108 would like to receive quotes from. The consumer 108 can provide the selection via return email or via the web portal. The data management server 104, upon receiving the selection, can send the time-variant data to the selected insurance providers 112.

In some implementations, the data management server 104 can maintain anonymity of the consumer 108 to the insurance providers 112. For example, the data management server 104 may provide only the time-variant data from the retail device 102 to the insurance provider 112 without identifying information for the consumer 108. In another example, the data management server 104 can provide limited or general identifying information for the consumer 108 and/or the item or intangible to be insured (along with the time-variant data) such that the insurance provider 112 can generate an accurate quote, but without providing enough information to uniquely identify the consumer 108 or the item/intangible to be insured. This can enable the consumer 108 to choose not to pursue insurance with an insurance provider 112 and the time-variant data will not be associated with the consumer 108 by the insurance provider 112. Thus, if the consumer 108 chooses to reapply for insurance with the insurance provider 112, the previous time-variant data 112 will not be associated with the consumer 108.

Moreover, the consumer 108 and the data management entity 110 can tailor what time-variant data is provided to the insurance provider. For example, the data management server 104, upon accumulating an amount of time-variant data from the retail module 102, can generate metrics for the consumer 108 as an indication of how the insurance provider(s) 112 are likely to quote based on the given set of time-variant data. One implementation of such a metric may be a driving score, where a high driving score corresponds to a likelihood that an insurance provider 112 will give a favorable quote based on the time-variant data and a low driving score corresponds to a likelihood that an insurance provider 112 will give an un-favorable quote. This information can be provided from the data management server 104 to the consumer 108 in any appropriate manner, such as by email or web portal as discussed above. Upon receiving the metric, the customer 108 may choose whether to request a quote from a given insurance provider 112 or wait for a later date in hopes of obtaining more favorable time-variant data. In some implementations, the driving score provided by the data management server 104 can be generally applicable to all insurance providers 112. In other implementations, the driving score can be specific to a particular insurance provider 112. That is, the data management server 104 can provide the customer 108 multiple driving scores, each driving score corresponding to a particular insurance provider 112. The data management server 104 can generate such a specifically tailored driving score based on historical data from other quotes provided to other customers of the data management entity 104 or based on publicly available information, such as information provided to the government by the insurance provider 112. Alternatively, the data management server 104 can provide the time-variant data to a third party and receive the metric from the third party. The data management entity 110 can also provide estimates of quotes to the consumer 108 for a given set of time-variant data for a given insurance provider 112 in a similar manner.

In some examples, the data management server 104 can aid the consumer 108 in selecting a subset of the accumulated time-variant data to provide to the insurance provider 112. For example, upon accumulating 3 months' worth of time-variant data, the data management server 104 can select a subset of the time-variant data (e.g., a contiguous block of data) that is believed to generate the most favorable quote. This subset can then be provided to the insurance provider 112. In some examples, however, an insurance provider 112 may place restrictions on how or whether subsets of data can be used.

The data management entity 110 can receive payment from one or more of the insurance providers 112. In an example, an insurance provider 112 can pay the data management server 104 for leads. In such an example, the data management server 104 can, but need not, provide time-variant data from the retail device 102 to the insurance provider 112. The fact that a consumer 108 purchased or otherwise obtained a retail module 102 is evidence that the consumer 108 is interested in insurance. Identifying a consumer 108 that is interested in insurance (a lead) may be valuable information for an insurance provider 112, such that the data management entity 110 can provide identification information for such a consumer 108 that has purchased a retail module 102 to the insurance provider 112 in exchange for a payment. In some implementations, the data management entity 110 can provide such identifying information for the consumer 108 soon after receiving such identifying information, such as after provisioning of the retail module 102.

In another implementation, a data management entity 110 can receive a portion of the insurance payment to the insurance provider 112 resulting from the information provided by the data management server 104. For example, upon receiving one or more quotes from one or more insurance providers 112, the consumer 108 can provide a selection of which insurance provider 112 the consumer 108 would like to open a policy with to the data management entity 110 (e.g., to the data management server 104 via a selection in a web-portal). The insurance broker server 104 can forward this selection to the selected insurance provider 112 which can then open a policy for the consumer 108 and obtain payment from the consumer 108. A portion of the payment (e.g., each monthly payment) from the consumer 108 can be allocated to the data management entity 110. In examples where the retail module 102 is purchased (i.e., not given away for free), the data management server 104 can also receive payment from the retail outlet selling the retail module 102 for the retail module 102.

In some implementations, the data management server 104 can continue to receive time-variant data from the retail module 102 after an insurance policy has been opened by the consumer 108. In such implementations, the data management server 104 can periodically provide the accumulated time-variant data to the insurance provider 112 with which the policy is opened. The insurance provider 112 can use the information as they see fit, such as to update the policy or quote for the consumer 108. In another example, the data management server 104 can periodically or at the demand of the consumer 108 provide the time-variant data or a subset thereof to one or more of the insurance providers 112 that do not currently have the policy open with the consumer 108. The one or more other insurance providers 112 can then provide quotes to the consumer 108 which the consumer 108 can compare to its current policy to determine if they wish to switch. In some examples, the insurance provider 112 with which a policy has been opened may desire to restrict use of the time-variant data from the retail module 102 such that the time-variant data cannot be provided to other insurance providers 112. In such examples, the data management server 104 can restrict use of the time-variant data, such that the data is only sent to the appropriate insurance provider 112 and may, in some implementations, be used for value added services.

The data management entity 110 can also provide value added services for the consumer 108 that are not directly related to insurance, but are enabled by the accumulated time-variant data. For example, the data management server 104 can maintain a web-portal as discussed above to which the consumer 108 can log-in; and in addition to metrics, insurance quotes, and insurance provider information, the web-portal can provide other information enabled by the time-variant data. For example, in implementations where the retail module 102 is configured to obtain or otherwise generate data on driving characteristics of a vehicle, the data management server 104 can provide information on such driving characteristics on the web-portal. For example, the data management server 104 can provide information on where the car has been driven, the average speed, the amount of sudden stops, diagnostic of vehicle problems (e.g., via decoding error codes from the vehicle's data bus) and so on. Similar value added services can be provided for time-variant data related to other types of insurance, such as heart rate information from a heart rate monitor.

Returning to the example where the retail module 102 is configured to obtain or otherwise generate data on driving characteristics of a vehicle, the data management server 104 can determine if assistance is needed at the vehicle, such as if a tow-truck, gas refill, or emergency services are needed. If such a determination is made, the data management server 104 can automatically call a tow-truck or 911 and report the information it has along with the location of the vehicle if such information is available in the time-variant data.

In another implementation of an example where the retail module 102 is configured to obtain data from a data bus of a vehicle, the retail module 102 can obtain repair related information from the data bus of the vehicle and provide such information to data management server 104. Examples of repair related information include error codes produced by the computer onboard the vehicle. The data management server 104 can send the repair related information to one or more vehicle repair shops and/or one or more vehicle part supply stores. The data management server 104 may also send some identifying information regarding the vehicle (e.g., make and model) or the consumer 108. The data management server 104 can use a current location of the vehicle (e.g., obtained from a GPS that is part of or associated with the retail module 102) or a home address for the consumer 108 to determine which repair shops or vehicle part supply stores are nearby. The vehicle repair shops or vehicle supply stores can then reply to the data management server 104 with quotes for service and/or parts to fix the repair. These quotes can be made available to the consumer 108 in any appropriate manner such as by email or web-portal as discussed above.

In yet another implementation of the example where the retail module 102 is configured to obtain or otherwise generate data on driving characteristics of a vehicle, the data management server 104 could store information received from the retail module 102 and generate a report from the data for a prospective purchaser of the vehicle. The prospective purchaser could then be able to see data regarding how the vehicle was driven.

In one example where the data management server 104 receives time-variant data corresponding to driving characteristics of a vehicle, the time-variant data is received from a module that is part of the vehicle as manufactured (e.g., is an OEM module). Such a module can obtain the time-variant data from the vehicle data bus and/or generate its own data with one or more sensors in the same manner as described with respect to retail module 102. Additionally, such a module can communicate with the data management server 104 using any of the manners as described with respect to the retail module 102. The main difference between such a module and the retail module 102 is that the OEM module is not purchased by the consumer 108 in a retail store. Instead the OEM module is part of the vehicle as manufactured. Such an OEM module can be provisioned by the consumer 108 after purchasing of the vehicle.

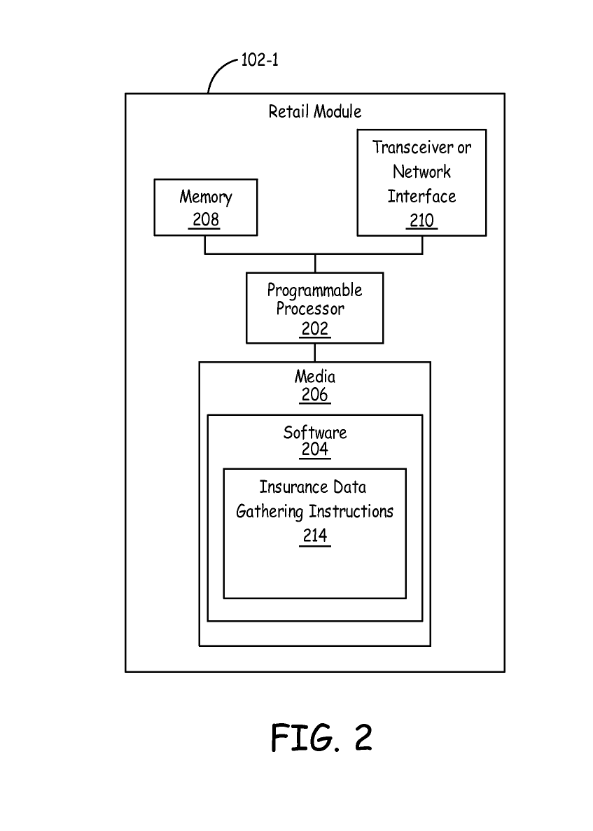

FIG. 2 is a block diagram of an example of a retail module 102-1 or OEM module, where the module 102-1 is an electronic device. Module 102-1 is an electronic device including one or more processing devices 202 for executing instructions 204. The one or more processing devices 202 can include a general purpose processor or a special purpose processor. The instructions 204 are stored (or otherwise embodied) on or in an appropriate storage medium or media 206 (such as flash or other non-volatile memory) from which the instructions 204 are readable by the programmable processor(s) 202 for execution thereby. The module 102-1 also includes memory 208 that is coupled to the programmable processor(s) 202 for storing instructions (and related data) during execution by the programmable processor(s) 202. Memory 208 comprises, in one implementation, any suitable form of random access memory (RAM) now known or later developed, such as dynamic random access memory (DRAM). In other implementations, other types of memory are used. The module 102-1 also includes a transceiver or network interface 210 for communicatively coupling the module 102-1 to other devices or networks. The instructions 204 include time-variant data gathering instructions 214 that are configured to cause the programmable processor(s) 202 to implement the functions of the retail module 102 described above.

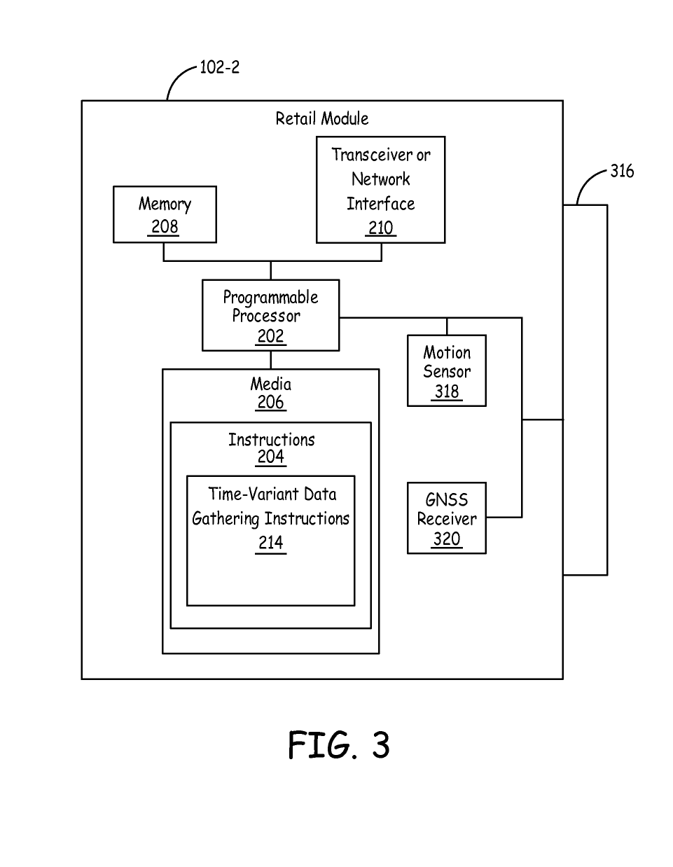

FIG. 3 is a block diagram an example of a retail module 102-2, where the retail module is configured to be installed in a vehicle and coupled to the vehicle's data bus through an appropriate connector such as an SAE-J1978 or OBD-II connector. Similar number components of retail module 102-2 function similarly to those described with respect to retail module 102-1 and several have additional functionality as described below. Retail module 102-2 includes a connector 316 (such as a SAE-J1978 or OBD-II connector) for connecting to a complementary SAE-J1978 or OBD-II connector on the vehicle. In addition, the time-variant data gathering instructions 214 are configured to cause the programmable processor(s) 202 to monitor or provide direct requests to the vehicle data bus through the connector 316. The retail module 102-2 also includes one or more motion sensors 318, such as an accelerometer and/or gyroscope, for sensing the motion of the vehicle. The time-variant data gathering instructions 214 are also configured to cause the programmable processor(s) 202 to receive data from the motion sensor 318. Finally, the retail module 102-2 includes a GNSS receiver 320 (e.g., a GPS receiver) for obtaining position data and/or speed from satellite signals. The time-variant data gathering instructions 214 are configured to cause the programmable processor(s) 202 to receive position data from the GNSS receiver 320.

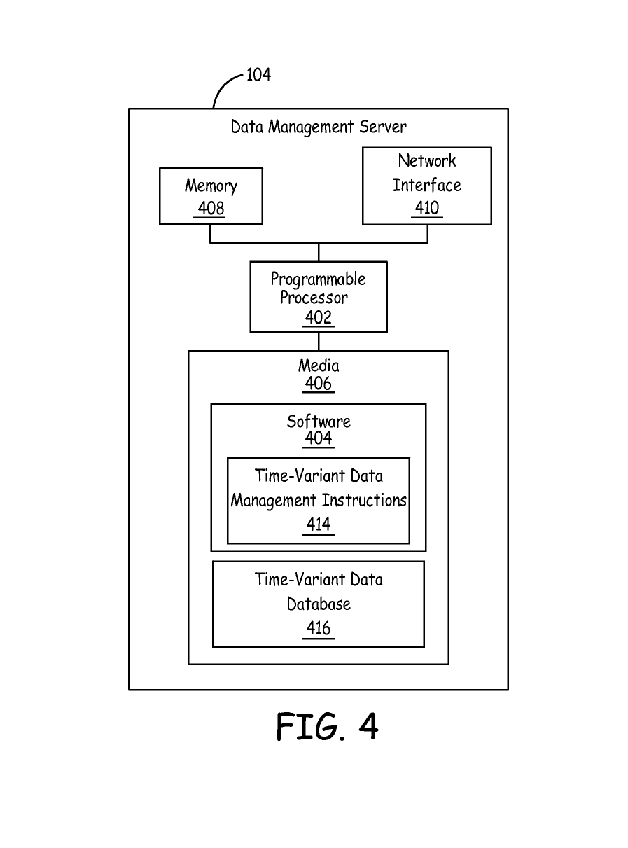

FIG. 4 is a block diagram of an example data management server 104. Server 104 includes one or more processing devices 402 for executing instructions 404. The one or more processing devices 402 can include a general purpose processor or a special purpose processor. The instructions 404 are stored (or otherwise embodied) on or in an appropriate storage medium or media 406 (such as flash or other non-volatile memory) from which the instructions 404 are readable by the programmable processor(s) 402 for execution thereby. The server 104 also includes memory 408 that is coupled to the programmable processor(s) 402 for storing instructions (and related data) during execution by the programmable processor(s) 402. Memory 408 comprises, in one implementation, any suitable form of random access memory (RAM) now known or later developed, such as dynamic random access memory (DRAM). In other implementations, other types of memory are used. The server 104 also includes a network interface 410 for communicatively coupling the server 104 to other devices or networks. The instructions 404 include time-variant data management instructions 414 that are configured to cause the programmable processor(s) 202 to implement the functions of the data management server 104 described above. Also on the media 406 is the time-variant data database or other file structure 416 that includes the time-variant data, consumer identification information, retail module identification information, as well as their associations.

What is claimed is:

1. A method for data management for insurance purposes, the method comprising:
receiving, at a server, time-variant data from a retail module configured to obtain the time-variant data, wherein the time-variant data pertains to an item or intangible to be insured;
receiving, at the server, identification information from the retail module;
determining a user account with which the retail module is associated based on the identification information;
receiving a selection from a user indicative of which one or more insurance providers to send the time-variant data to, wherein the user is associated with the user account; and
providing, from the server, the time-variant data to the one or more insurance providers selected by the user.

2. The method of claim 1, comprising:
receiving, at the server, one or more quotes for insurance of the item or intangible to be insured from the one or more insurance providers; and
providing, from the server, the one or more quotes to a user associated with the user account.

3. The method of claim 1, receiving payment from the one or more insurance providers in response to providing the time-variant data thereto.

4. The method of claim 1, comprising:
receiving a selection from a user indicating a subset of the time-variant data to provide to the one or more insurance providers.

5. The method of claim 1, comprising:
providing information identifying a user associated with the user account to the one or more insurance providers along with the time-variant data.

6. The method of claim 1, comprising:
maintaining anonymity of the user associated with the user account from the insurance providers during generation of the one or more quotes based on the time-variant data.

7. The method of claim 1, comprising:
aggregating time-variant data from multiple retail modules for a single user account, wherein providing time-variant data to one or more insurance providers includes providing the aggregated time-variant data from the multiple retail modules to the one or more insurance providers.

8. The method of claim 1, receiving payment from the one or more insurance providers if the consumer opens an insurance policy with the one or more insurance providers based on the quotes.

9. A system for data management for insurance purposes, the system comprising:
a plurality of retail modules, each retail module configured to obtain or generate time-variant data corresponding to an item or intangible to be insured;
a data management server configured to:
receive the time-variant data from the plurality of retail modules;
receive identification information from the plurality of retail modules;
determine a user account with which the retail module is associated based on the identification information;
receive a selection from a user indicating which one or more insurance providers to send the time-variant data to, the user associated with the user account; and
provide the time-variant data to the one or more insurance providers selected by the user.

10. The system of claim 9, wherein the data management server is configured to:
receive one or more quotes for insurance of the item or intangible to be insured from the one or more insurance providers; and
provide the one or more quotes to a user associated with the user account.

11. The system of claim 9, wherein the data management server is configured to receive a selection from a user indicating a subset of the time-variant data to provide to the one or more insurance providers.

12. The system of claim 9, wherein the data management server is configured to provide information identifying a user associated with the user account to the one or more insurance providers along with the time-variant data.

13. The system of claim 9, wherein the data management server is configured to maintain anonymity of the user associated with the user account from the insurance providers during generation of the one or more quotes based on the time-variant data.

14. The system of claim 9, wherein the data management server is configured to aggregate time-variant data from multiple retail modules for a single user account, wherein providing time-variant data to one or more insurance providers includes providing the aggregated time-variant data from the multiple retail modules to the one or more insurance providers.

15. The system of claim 9, wherein the retail module is an electronic device configured to be installed in a vehicle, to obtain driving characteristics for the vehicle from an on-board diagnostics (OBD) port of the vehicle, and to communicate the data therefrom as time-variant data.

16. The system of claim 15, wherein the retail module is configured to communicate the time-variant data wirelessly to a cellular tower.

17. The system of claim 15, wherein the retail module is configured to sense motion and determine a location of the vehicle and send data corresponding to the motion and location to the server as time-variant data.

18. The system of claim 9, wherein the retail module is a software application for a mobile phone.

19. A method for data management for insurance purposes, the method comprising:
receiving, at a server, time-variant data from a retail module configured to obtain the time-variant data, wherein the time-variant data pertains to an item or intangible to be insured;
receiving, at the server, identification information from the retail module;
determining a user account with which the retail module is associated based on the identification information;
providing, from the server, the time-variant data to one or more insurance providers;
receiving, at the server, one or more quotes for insurance of the item or intangible to be insured from the one or more insurance providers; and
providing, from the server, the one or more quotes to a user associated with the user account.

20. The method of claim 19, comprising:
receiving payment from the one or more insurance providers in response to providing the time-variant data thereto.
